(19) United States
(12) Patent Application Publication
(10) Pub. No.: US 2019/0268845 A1
(43) Pub. Date: Aug. 29, 2019

(54) POWER SAVE IN MACHINE TYPE COMMUNICATION DEVICE

(71) Applicant: Intel IP Corporation, Santa Clara, CA (US)

(72) Inventor: Nirlesh K. Koshta, Bangalore, Ka (IN)

(21) Appl. No.: 15/738,979

(22) PCT Filed: Jun. 22, 2016
(86) PCT No.: PCT/US16/38690

§ 371 Date: Mar. 19, 2018

(30) Foreign Application Priority Data
Jun. 26, 2015 (IN) 3221/CHE/2015

(51) Int. Cl. H04W 52/02; H04W 4/70

(52) U.S. Cl. CPC H04W 52/0216; H04W 4/70; H04W 52/0229

(57) ABSTRACT

Configuring a Machine Type Communication (MTC) device having an application and configured to operate on a wireless communication network, by identifying, by a processor, a value of a network periodic update timer; and synchronizing, by a platform, a value of an application periodic reporting timer of the application and the value of the network periodic update timer.

### TECHNICAL FIELD

The present disclosure relates generally to a Machine Type Communication (MTC) device, and more specifically, to saving power in an MTC device required to send updated data periodically to a remote server.

### BACKGROUND

The Internet of Things (IoT) is a network of devices, such as Machine Type Communication (MTC) devices, embedded with electronics, software, sensors and connectivity to enable the network to achieve greater value and service by exchanging data with the manufacturer, operator and/or other connected devices.

Wireless communication specifications generally require that a device stay camped on the network, even when the device is not performing any cell-selection/reselection or expects any network initiated connection establishment procedures, as in the case of stationary MTC devices. Cell measurements are required even for stationary devices, thus increasing current consumption

### BRIEF DESCRIPTION OF THE DRAWINGS

FIG. 1 illustrates a general schematic diagram of a wireless communication system in accordance with an aspect of the disclosure.

FIG. 2 illustrates a more detailed schematic diagram of the wireless communication system in accordance with an aspect of the disclosure.

FIG. 3 illustrates a flowchart of a method in accordance with an aspect of the disclosure.

FIG. 4 illustrates a Machine Type Communication (MTC) device in accordance with an aspect of the disclosure.

### DESCRIPTION OF THE ASPECTS

The present disclosure is directed to saving power in a Machine Type Communication (MTC) device which is required to send updated data periodically to a remote server. The MTC device does not expect any incoming calls or messages and does not require network initiated connection establishment procedures. Between data transfers from the MTC device to the remote server, an application/platform of the MTC device can thus deactivate and then reactivate the MTC's protocol stack in order to save power.

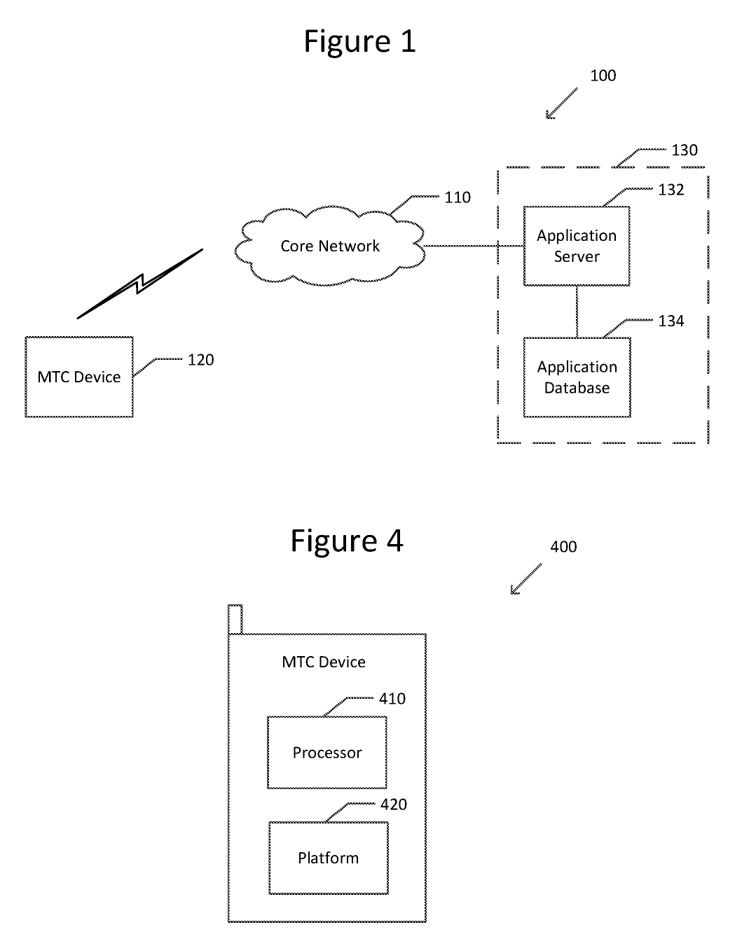

FIG. 1 illustrates a general schematic diagram of a wireless communication system 100 in accordance with an aspect of the disclosure.

The network 100 comprises a core wireless network 110, one or more MTC devices 120, and one or more remote application servers 130. The core wireless network 110 is disclosed as being a network based on the 3rd Generation Partnership Project (3GPP) protocol, though the disclosure is not limited in this respect. The core wireless network 110 may be based on any protocol requiring periodic updating. The remote application server 130 is shown as being coupled to the core network 110 by wireline, but it is understood that at least some portion of this connection may be wireless.

The MTC device 120 remains stationary for its entire existence. Examples of such an MTC device 120 include stationary appliances, such as air conditioners, which are located within home or industry and update temperature readings to the application server 130. Based on the readings, a technician can initiate repair or replacement service if necessary.

The remote application server 130 comprises an application server 132 and database 134. The database 134 is configured to store application monitoring data received from the MTC device 120.

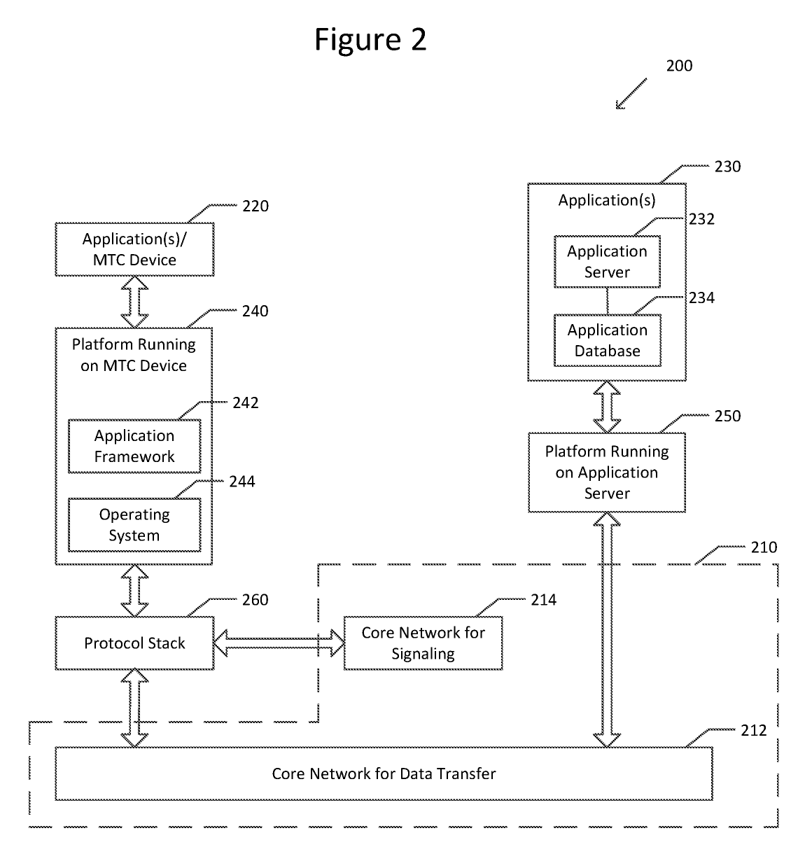

FIG. 2 illustrates a more detailed schematic diagram of a wireless communication system 200 in accordance with an aspect of the disclosure. System 200 of FIG. 2 is similar to the system 100 of FIG. 1, except that more detail is illustrated.

The system 200 comprises a core network 210, one or more applications/MTC devices 220, a platform 240 running on the MTC device, a protocol stack 260, one or more application servers 230, and a platform 250 running on the application server 232.

The core network 210 comprises of a core network for data transfer exchange 212 and a core network for signaling exchange 214. The core network for signaling exchange 214 is configured to authenticate and create a Packet Data Network (PDN) context for the MTC device 220. The core network for data exchange 212 represents the data transfer that takes place between the application MTC device 220 and the application server 232.

The platform running on the MTC device 240 comprises an application framework 242 and an operating system 224. As is known, a platform is, in the most general sense, the environment computer software or code object is designed to run within. A platform can refer to hardware architecture, an operating system (OS), and runtime libraries.

The protocol stack 260, as is known, is an implementation of a computer networking protocol suite. In 3GPP, for example, the radio interface is layered into three protocol layers—physical layer (L1), data link layer (L2), and network layer (L3).

During operation, an application running on the MTC device 220 is powered on. The application 220, via the platform 240, activates the protocol stack 260 and performs location registration to core the network 210. In 3GPP, the registration involves the core network for signaling exchange 214 configured to perform the known ATTACH request procedure to create a context in the core network 210. In case of LTE, the ATTACH request procedure creates a default Packet Data Network (PDN) context.

The MTC device 220 then obtains a value of a network periodic update timer T3412/T3312, which sets the timing for updating MTC device monitoring data to the core network 210. T3312 is the timer used in second generation (2G) and third generation (3G) wireless protocols, and T3412 is the timer used in Long Term Evolution (LTE). When the timer T3412/T3312 expires, the platform 240 reports device monitoring data, such as location, to the core network 210. In 3GPP Release 10, the maximum periodic timer values can be up to about 310 hours. Prior to Release 10, the maximum periodic timer values were up to 3 hours.

The value of the network periodic update timer T3412/T3312 may be received by the MTC device 220 from the core network 210 in the TAU/RAU/ATTACH accept message. For 3GPP Release 11 and prior releases, this was the only process for setting the timer. Starting in 3GPP Release 12, the MTC device 220 has the option of providing a network periodic update timer value to the core network 210, and then the core network 210 accepts the provided value or sends a different value. The protocol stack 260 updates the platform 240 running on the MTC device 220 with the determined periodic network timer value. Optionally, the protocol stack 260 can also update the received network periodic timer value to the application server 232 if the timer is found to be different from the one requested.

Next, the MTC device application 220 activates in case of a 2G/3G network, a Packet Data Protocol (PDP) context. The application that is running on the platform 240 then initiates sending MTC device data to the core network 232.

In addition to the network periodic update timer T3412/T3312, the MTC device application 220 has an application periodic reporting timer that sets the frequency at which the MTC device 220 sends to the remote application server 232 application monitoring data. In the case of the MTC device 220 being an air conditioner, for example, this monitoring data might be temperature.

In case of 3GPP pre-Release 12, to save power in the MTC device 220, the protocol stack 260 (layers 1 and 2) is deactivated (switched off) when it is not sending data, and then reactivated (switched on) periodically to send data. More specifically, the MTC device 220 is stationary, and thus does not listen to calls or do anything in the periods between sending data. During these periods the protocol stack 260 can therefore be deactivated. In case of 3GPP Release 12 and above, the MTC device 220 deactivates the L1 and L2 layers after the timer 3324 expires.

The amount of time the protocol stack can be deactivated, or its L1 and L2 layers being deactivated, is determined by the platform 240 based on the periodic network timer and the application periodic reporting timer. Alternatively, this determination may be made by the application 220.

For example, if the network periodic update timer value is greater than the application periodic reporting timer value, for example, the network periodic update timer value is five hours and the application periodic reporting timer value required by the application 220 is one hour, then the protocol stack 260 can be deactivated for one hour. The network periodic update timer would be stopped and the application periodic reporting timer would be running. When the application periodic reporting timer expires after the one hour, the application 220 needs to send application monitoring data to the application server 132. The platform 240 activates the protocol stack 260, does an ATTACH, creates a PDN/PDP context if not created as part of the ATTACH procedure, and the MTC device 220 sends packet(s) with application monitoring data to the application server 232. Once the application monitoring data has been set, the platform 240 deactivates the protocol stack 260 for the remaining duration of the hour. When the one-hour application periodic reporting timer expires again, this process is repeated.

By way of another example, the application periodic reporting timer value is of a small value as compared to the network periodic update timer value, for example, the network periodic update timer value is one hour and the application periodic reporting timer value required by the application 220 is 10 minutes. The MTC device 220 runs the network periodic update timer at the application layer (for 3GPP pre-Release 12 cases) and deactivates the L1 and L2 layers in the protocol stack 260. For 3GPP Release 12 and above, the MTC device 220 in accordance with the 3GPP specifications sends timer 3324 and 3412/3312 timer values as chosen by the application to the network. When the periodic network timer of one hour expires, the platform 240 activates the protocol stack 260, activates the radio bearers for the already existing PDN/PDP context, and then the L1 and L2 layers in the protocol stack 260 is deactivated. Similarly, when the application periodic reporting timer expires, the platform 240 activates the L1 and L2 layers in the protocol stack 260, activates the radio bearers for the already existing PDN/PDP context, and the MTC device 220 sends packet(s) with application monitoring data to the application server 232, and then the platform 240 deactivates the L1 & L2 layers present in the protocol stack 260.

3GPP Release 12 and prior releases have no concept of deactivating the protocol stack 260, or L1 and L2 layers of the protocol stack 260. The MTC device 220 remains on, listening to neighboring cells to determine whether its location has changed based on received power levels of neighboring cells. Once the timer expires, the MTC device 220 updates its location to the core network 210.

The application periodic reporting timer can be synchronized with the periodic network timer. That is, the platform 260, or alternatively the application 220, may modify the value of the application periodic reporting timer to equate to the value of the network periodic update timer (T3412/T3312). This modification is particularly useful when the value of the network periodic update timer is less than the value of the application periodic reporting timer. For example, if the periodic network timer is one hour, and if the application periodic reporting timer is two hours, there will be establishment of radio link signaling every hour for the network location update, so the application periodic reporting timer can be changed to one hour to improve the accuracy of the application data reporting.

The logic controlling the shutdown of L1 and L2 layers of protocol stack 260 is preferably handled by the application framework 242 so that the application developers need not create additional logic in the application running on the application framework 242. The application framework 242 uses a software development kit and exposes Application Programming Interfaces (APIs) over the OS 244. The OS 244 obtains data from a sensor and sends the data to a processor of the MTC device 220.

The application server 232 controls the timer value for which the MTC device 220 remains active or deactivates the protocol stack 260, or the L1 and L2 layers of the protocol stack 260. The application periodic reporting timer values are controlled by the application server 232 and can be modified by the application server 232 when the MTC device 220 connects with the application server 232. Thus the application server 232 decides if the protocol stack 260 can be deactivated entirely (does not perform periodic network updates), the MTC device 220 merely reports the application monitoring data periodically, or the MTC device 220 must shut down its L1 and L2 layers in the protocol stack 260. All of this can be controlled by the application framework running on the server 230 and the MTC device 220.

As a further feature, in case of 3GPP pre-release 12 the MTC device 220 has the option to send the periodic network timer value to the application server 232, so that the application server 232 knows when the MTC device 220 will be in contact next. For example, the application periodic reporting timer may be 45 minutes, and the periodic network timer one hour. After 45 minutes the MTC device 220 has updated to the application server 232 with the application monitoring data and the platform 240 has deactivated the L1 and L2 layers in the protocol stack 260. If then the application server 232 has a configuration change and wants to update the MTC device 220 again to change the configuration, it is not possible at this time because the MTC device has deactivated its protocol stack 260. Since the periodic network timer was provided to the application server 232, the application server 232 knows that after 15 minutes the MTC device 220 will send the MTC device monitoring data to the core network 210. So the application server 232 knows that after fifteen minutes the MTC device 220 will be active, and the application server 232 can ping the MTC device 220 then. In case of 3GPP Release 12 onwards, application server can configure the MTC device 220 to send the required 3324 and 3412 timer values in the ATTACH/TAU/RAU messages. As an additional logic the accepted 3324 and 3412 timer values can be sent to the application server 232. The application server 232 can then configure the MTC device 220 with the appropriate application periodic reporting timer depending on the timer values received from the network.

Further, the application server 232 can modify the application periodic reporting timer of the MTC 220 device based on tasks it is designating to the MTC device 220. The application server 232 sets up tasks that the MTC device 220 is to perform. Once these tasks are done, the MTC device 220 will report the results to the application server 232. The value of the application periodic reporting timer can be configured taking into consideration the minutes required to perform the tasks. Task examples include taking 100 observation points in five-minute intervals for a total of 500 minutes, or taking 30 observation points over ten-minute intervals for a total of 300 minutes.

If the MTC device 220 determines that it needs to report an emergency event to the network 210, it may do so independent of the value of either the network periodic update timer or the value of the application periodic reporting timer has expired. The MTC device 220 will initiate activation of the L1 and L2 layers in the protocol stack 260 and update the emergency event to the server 132 immediately.

Timer T3324 was introduced in 3GPP Release 12 and sets the predetermined period of time for which, after the MTC device 220 sends monitoring data to the core network 210, the Radio Resource Control (RRC) connection remains active. Once the timer T3324 expires, the RRC connection is released, and the MTC device 220 deactivates its L1 and L2 layers in protocol stack 260, unless there is a need by the application, or there is a periodic update required by the MTC device 220. Timer T3324 is assigned by the core network 210 to the MTC device 220.

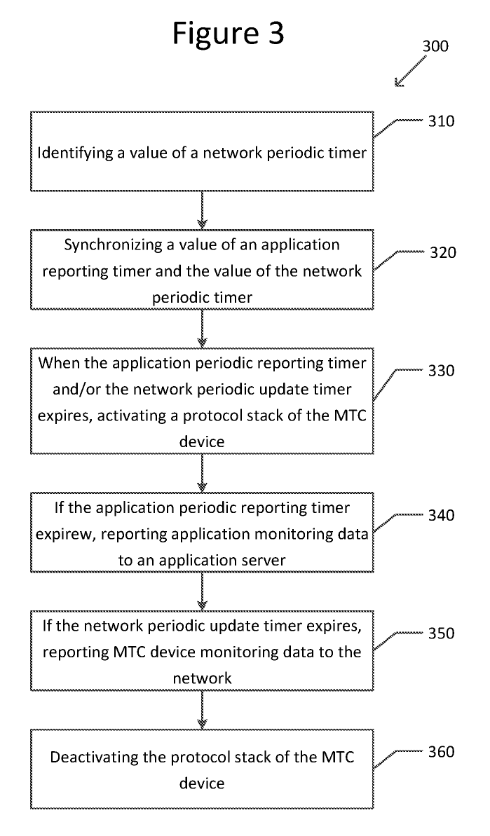

FIG. 3 illustrates a flowchart of a method 300 in accordance with an aspect of the disclosure.

At Step 310, the MTC device 220 identifies a value of a network periodic update timer.

At Step 320, the processor 410 synchronizes a value of an application periodic reporting timer and the value of the network periodic update timer.

At Step 330, when the application periodic reporting timer and/or the network periodic update timer expires, the application framework 242 activates the protocol stack 260 or the L1 and L2 layers of the protocol stack of the MTC device 220.

At Step 340, the MTC device 220 reports application monitoring data to an application server if the application periodic reporting timer expired, and at Step 350 performs periodic update to core network 210 if the network periodic update timer expired.

At Step 350, the application framework 242 deactivates the protocol stack 260 or the L1 and L2 layers of the protocol stack of the MTC device 220.

FIG. 4 illustrates a Machine Type Communication (MTC) device 400 in accordance with an aspect of the disclosure. The MTC device 410 comprises a processor 410 and a platform 420, among other elements not shown. The processor 410 is configured to determine a value of a network periodic update timer. The platform 420 is configured to synchronize a value of an application periodic reporting timer and the value of the network periodic update timer. The platform 420 is further configured to modify the value of the application periodic reporting timer to equate to the value of the network periodic update timer in some cases. Also, the platform 420 is further configured to modify the value of the application periodic reporting timer by the value received from application server 232.

Example 1 is a method of operating a Machine Type Communication (MTC) device having an application and configured to operate on a wireless communication network, the method comprising: identifying, by a processor, a value of a network periodic update timer; and synchronizing, by a platform, a value of an application periodic reporting timer of the application and the value of the network periodic update timer.

In Example 2, the subject matter of Example 1, wherein the synchronizing comprises modifying the value of the application periodic reporting timer to be equal the value of the network periodic update timer.

In Example 3, the subject matter of Example 1, further comprising: updating the network periodic timer value to a remote application server configured to operate on the network.

In Example 4, the subject matter of Example 1, wherein if the value of the network periodic update timer is less than the value of the application periodic reporting timer, then the synchronizing comprises modifying the value of the application periodic reporting timer to equate to the value of the network periodic update timer.

In Example 5, the subject matter of Example 1, further comprising: reporting application monitoring data to a remote application server configured to operate on the network, when the application periodic reporting timer expires.

In Example 6, the subject matter of Example 5, further comprising: deactivating a protocol stack of the MTC device after the reporting.

In Example 7, the subject matter of Example 6, wherein the deactivating is performed after a predetermined period of time after the reporting.

In Example 8, the subject matter of Example 1, wherein when the application periodic reporting timer expires, further comprising: activating a protocol stack of the MTC device; reporting application monitoring data to a remote application server configured to operate on the network; and deactivating the protocol stack of the MTC device.

In Example 9, the subject matter of Example 8, wherein the deactivating is performed after a predetermined period of time after the reporting.

In Example 10, the subject matter of Example 1, wherein the network is a 3rd Generation Partnership Project (3GPP) network.

In Example 11, the subject matter of Example 1, further comprising: reporting an emergency event to the network independent of the value of the network periodic update timer or the value of the application periodic reporting timer being expired.

Example 12 is a Machine Type Communication (MTC) device having an application and configured to operate on a wireless communication network, the MTC device comprising: a processor configured to identify a value of a network periodic update timer; and a platform configured to synchronize a value of an application periodic reporting timer of the application and the value of the network periodic update timer.

In Example 13, the subject matter of Example 12, wherein the platform is further configured to modify the value of the application periodic reporting timer to equate to the value of the network periodic update timer when the value of the network periodic update timer is less than the value of the application periodic reporting timer.

In Example 14, the subject matter of Example 12, wherein the platform is further configured to report application monitoring data to a remote application server configured to operate on the network, when the application periodic reporting timer expires.

In Example 15, the subject matter of Example 14, further comprising: a protocol stack configured to be deactivated after the reporting.

Example 16 is a Machine Type Communication (MTC) device having an application and configured to operate on a wireless communication network, the MTC device comprising: a processor configured to identify a value of a network periodic update timer; and a platform means for synchronizing a value of an application periodic reporting timer of the application and the value of the network periodic update timer.

In Example 17, the subject matter of Example 16, wherein the platform means is further for modifying the value of the application periodic reporting timer to equate to the value of the network periodic update timer when the value of the network periodic update timer is less than the value of the application periodic reporting timer.

In Example 18, the subject matter of Example 16, wherein the application framework means is further for reporting application monitoring data to a remote application server configured to operate on the network, when the application periodic reporting timer expires.

In Example 19, the subject matter of Example 18, further comprising: a protocol stack means for being deactivated after the reporting.

Example 20 is a computer program product embodied on a non-transitory computer-readable medium comprising program instructions configured such that when executed by processing circuitry cause the processing circuitry to implement the subject matter of Example 1.

In Example 21, the subject matter of any of Examples 1-2, further comprising: updating the network periodic timer value to a remote application server configured to operate on the network.

In Example 22, the subject matter of any of Examples 1-3, wherein if the value of the network periodic update timer is less than the value of the application periodic reporting timer, then the synchronizing comprises modifying the value of the application periodic reporting timer to equate to the value of the network periodic update timer.

In Example 23, the subject matter of any of Examples 1-4, further comprising: reporting application monitoring data to a remote application server configured to operate on the network, when the application periodic reporting timer expires.

In Example 24, the subject matter of any of Examples 1-5, wherein when the application periodic reporting timer expires, further comprising: activating a protocol stack of the MTC device; reporting application monitoring data to a remote application server configured to operate on the network; and deactivating the protocol stack of the MTC device.

In Example 25, the subject matter of any of Examples 1-9, wherein the network is a 3rd Generation Partnership Project (3GPP) network.

In Example 26, the subject matter of any of Examples 1-10, further comprising: reporting an emergency event to the network independent of the value of the network periodic update timer or the value of the application periodic reporting timer being expired.

In Example 27, the subject matter of any of Examples 12-13, wherein the platform is further configured to report application monitoring data to a remote application server configured to operate on the network, when the application periodic reporting timer expires.

In Example 28, the subject matter of any of Examples 16-17, wherein the application framework means is further for reporting application monitoring data to a remote application server configured to operate on the network, when the application periodic reporting timer expires.

Example 29 is an apparatus as substantially shown and described.

Example 30 is a method as substantially shown and described.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1-20. (canceled)

21. A method of operating a Machine Type Communication (MTC) device having an application and configured to operate on a wireless communication network, the method comprising:
identifying, by a processor, a value of a network periodic update timer; and
synchronizing, by a platform, a value of an application periodic reporting timer of the application and the value of the network periodic update timer.

22. The method of claim 21, wherein the synchronizing comprises modifying the value of the application periodic reporting timer to equate to the value of the network periodic update timer.

23. The method of claim 21, further comprising:
updating the network periodic timer value to a remote application server configured to operate on the network.

24. The method of claim 21, wherein if the value of the network periodic update timer is less than the value of the application periodic reporting timer, the synchronizing comprises modifying the value of the application periodic reporting timer to equate to the value of the network periodic update timer.

25. The method of claim 21, further comprising:
reporting application monitoring data to a remote application server configured to operate on the network, when the application periodic reporting timer expires.

26. The method of claim 25, further comprising:
deactivating a protocol stack of the MTC device after the reporting.

27. The method of claim 26, wherein the deactivating is performed after a predetermined period of time after the reporting.

28. The method of claim 21, wherein when the application periodic reporting timer expires, further comprising:
activating a protocol stack of the MTC device;
reporting application monitoring data to a remote application server configured to operate on the network; and
deactivating the protocol stack of the MTC device.

29. The method of claim 28, wherein the deactivating is performed after a predetermined period of time after the reporting.

30. The method of claim 21, wherein the network is a 3rd Generation Partnership Project (3GPP) network.

31. The method of claim 21, further comprising:
reporting an emergency event to the network independent of the value of the network periodic update timer or the value of the application periodic reporting timer being expired.

32. A Machine Type Communication (MTC) device having an application and configured to operate on a wireless communication network, the MTC device comprising:
a processor configured to identify a value of a network periodic update timer; and
a platform configured to synchronize a value of an application periodic reporting timer of the application and the value of the network periodic update timer.

33. The MTC device of claim 32, wherein the platform is further configured to modify the value of the application periodic reporting timer to equate to the value of the network periodic update timer if the value of the network periodic update timer is less than the value of the application periodic reporting timer.

34. The MTC device of claim 32, wherein the platform is further configured to report application monitoring data to a remote application server configured to operate on the network, when the application periodic reporting timer expires.

35. The MTC device of claim 34, further comprising:
a protocol stack configured to be deactivated after the reporting.

36. A Machine Type Communication (MTC) device having an application and configured to operate on a wireless communication network, the MTC device comprising:
a processor configured to identify a value of a network periodic update timer; and
a platform means for synchronizing a value of an application periodic reporting timer of the application and the value of the network periodic update timer.

37. The MTC device of claim 36, wherein the platform means is further for modifying the value of the application periodic reporting timer to equate to the value of the network periodic update timer when the value of the network periodic update timer is less than the value of the application periodic reporting timer.

38. The MTC device of claim 36, wherein the application framework means is further for reporting application monitoring data to a remote application server configured to operate on the network, when the application periodic reporting timer expires.

39. The MTC device of claim 36, further comprising:
a protocol stack means for being deactivated after the reporting.

40. A computer program product embodied on a non-transitory computer-readable medium comprising program instructions configured such that when executed by processing circuitry cause the processing circuitry to implement the method of claim 1.
